(19) United States
(12) Patent Application Publication
(10) Pub. No.: US 2022/0379667 A1
(43) Pub. Date: Dec. 1, 2022

(54) Vehicle Tire Wear Extraction Filtration System

(71) Applicant: Joseph Gelb, Menifee, CA (US)

(72) Inventor: Joseph Gelb, Menifee, CA (US)

(21) Appl. No.: 17/750,782

(22) Filed: May 23, 2022

Related U.S. Application Data
(60) Provisional application No. 63/202,157, filed on May 28, 2021.

(51) Int. Cl. B60C 11/24; B60C 19/00; B60R 19/00

(52) U.S. Cl. CPC B60C 11/246; B60C 19/00; B60R 19/00

(57) ABSTRACT

Improvements in a vehicle tire wear extraction system, that places a tire wear extraction surface, comprising a flat or curved surface, behind the wheels of a vehicle tire in use. Fluid, e.g, electrically charged water to aid in the collection of debris that is pumped over the surfaces, and then filtered. The filtering removes the tire wear debris contaminant materials before they reach the ground. The system can include a self-contained stand-alone power supply to power the unit.

### CROSS REFERENCE TO RELATED APPLICATION

This application is a continuation-in-part of applicant's co-pending application Ser. No. 63/202,157 filed May 28, 2021 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in collection of tire wear debris. More particularly, the present vehicle tire wear extraction filtration system removes debris from tires and uses a washing system to collect the debris.

### Description of Related Art Including Information Disclosed Under 37 CFR 1.97 and 1.98

As tires are used to propel vehicles, small fragments of the tires wear off, and the worn materials usually end up on the road and surrounding environment. The tire wear debris materials become contaminants that can be very damaging to some species of aquatic life and the environment.

Prior art reference U.S. Pat. No. 7,094,268 describes a vehicle Tire Wear Extraction Filtration System. The present system overcomes many of the limitations of this patent an improvement for collecting tire wear debris at the source.

What is needed is a vehicle mounted system that removes debris from a tire and recycles the cleaning liquid in a continuous basis.

### BRIEF SUMMARY OF THE INVENTION

It is an object of the vehicle tire wear extraction filtration system to remove tire contaminants include rubber, additives, and preservatives, all of which are contaminants. The tires can also include other debris contaminants. Tests have shown that mixing some of these contaminants together create an all new chemical which is yet to be completely studied and defined but shown to be toxic in nature.

It is another object of the vehicle tire wear extraction filtration system to have different ways of extracting tire wear debris contaminants and chemicals from the tire while the tire is in use and before those contaminants are deposited on the road. This prevents those contaminants from eventually transported to the water table, streams, and oceans as pollutants. The present invention can be used on all vehicles, with 2 to 18 wheels including electric vehicles and trucks.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a vehicle tire wear extraction filtration flow system.

FIG. 2 shows the flow over / through the filter.

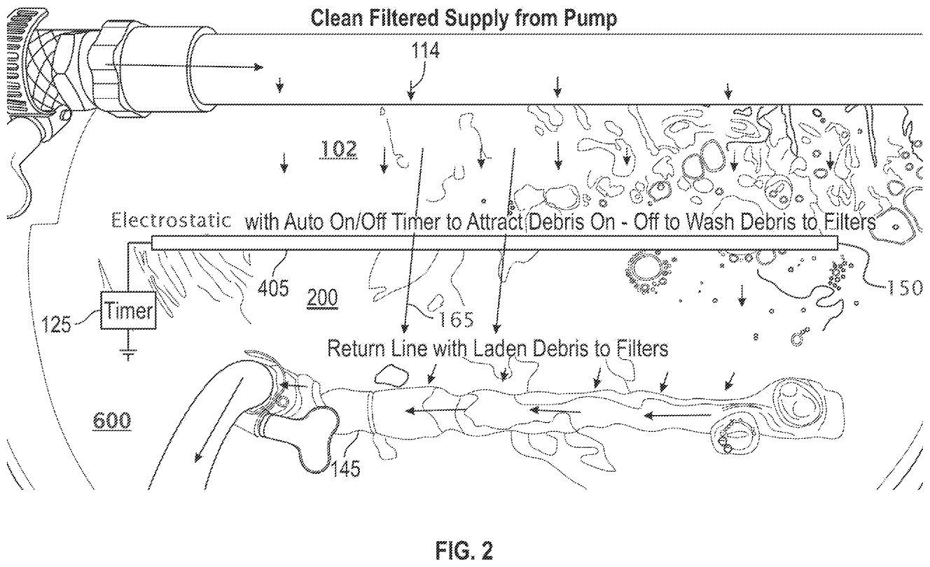

FIG. 3 shows a pictorial representation of the components.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Item Numbers and Description

| | |
|---|---|
| 100 tire wear extraction device | 102 flat or curved extraction plate |
| | surface |
| 110 filtered clean water flow | 112 supply line hose |
| 114 clean water | 120 electrostatic charged water element |
| 125 timer | 130 outlet hose |
| 135 one-way check valve | 140 water flow |
| 145 return hose | 150 filter element |
| 155 filtered liquid | 160 pump |
| 165 flow through | 170 surface area of a tire |
| 200 extraction plate area | 306 switch sensor |
| 405 charged line | 505 prefilter |
| 510 heater strip reservoir | 520 temperature control |
| 525 sensor | 530 heat strips |
| 531 sensor | 550 power connection |
| 555 car battery | 560 auxiliary battery |
| 570 separate flywheel magneto | 575 heating element |
| generator system | |
| 580 microcontroller | 600 electrostatic rod element |

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Embodiments describe a system which extracts tire wear debris contaminants directly from a tire while the tire is in use. The tire wear debris is transferred to filters and hence removed before these debris and particles reaches the road surface.

An embodiment uses a tire wear extraction and filtration system. In an embodiment, this filtration system is positioned directly behind one or more preferably all the tires, including 18-Wheel industrial vehicles. Debris from the tires is transferred into a filtration system and filtered out into a sealed cartridge for proper disposal.

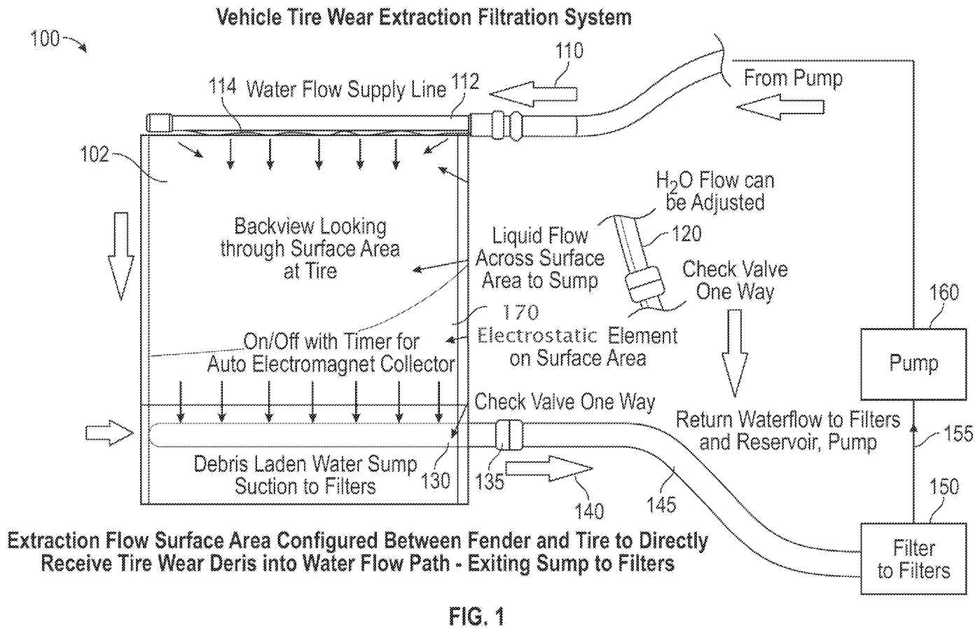

An embodiment is shown in FIG. 1. The tire wear extraction device 100 is formed of a flat or curved surface 102 which is shown in FIG. 1. In FIG. 1, the flat or curved extraction plate surface 102 faces towards the tire. A fluid, water or other suitable liquid is charged with an electric field, then pumped over the surface 102 in the direction of the filtered clean water flow 110 through a supply line hose 112. The flat or curved surface 102 can be covered with a screen or other partition layer to keep in the fluid from splashing or leaking out, but still allowing the contaminants to be held on the surface. The flat or curved surface 102 can have a sensor, such as a light sensor, photocell or cadmium cell that protect the system in dirty/muddy conditions that turns on when it senses light and off when dark or there is a dirty sensor covered with debris. Once the system and sensor are cleaned the system will see light and apply power to the system.

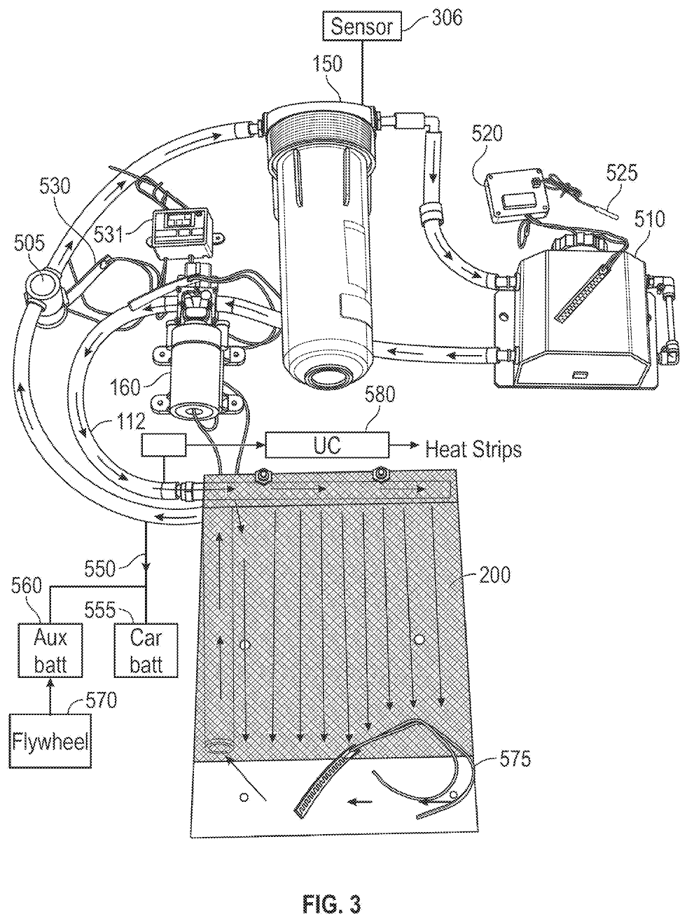

A suitable liquid or clean water 114 emerges from the supply line and passes a surface area of the tire 170. The fluid on the surface area collects the debris. In one embodiment, there can be an electrostatic charged water element 120 which can be over the entire surface area of surface 102, or just in certain areas. The electromagnet can attract the debris even further. There can also be a timer 125 or other kind of controller that turns on the electrostatic charged line 405 periodically along with a sensor moisture sensor that turns the entire pumping system off when rainwater is detected once sensor dries out system returns to normal as shown in FIG. 3.

In an embodiment, the fluid can be water, although other fluids or suitable liquid can also be used.

In an embodiment, the debris laden water is sent through a one-way check valve 135 in the water flow 140. The water flows 140 through return hose 145 is then filtered through a filter element 150. The filter can be in one embodiment a sealed filter cartridge with a 0.1 micron filter, that can be removed and replaced once full. The filtered liquid 155 is then returned through a pump 160 as the filtered clean water 110.

Once the sealed cartridge filter is filled, it can be replaced for proper disposal. This can be indicated by an in-vehicle dash light module and pump pressure limit switch sensor 306, as shown in FIG. 3.

The extraction plate flat or curved extraction plate surface 102 is connected to the supply line hose 112, and the outlet hose 130. In operation, the extraction plate area 200 is positioned directly behind the tire in use in the position of or in the place of a mud guard or fender. In an embodiment, there can be 4 or more of the extraction plates 200, one behind each tire positioned to receive and capture the contaminants from the tire.

Clean water 114, is provided from the pump with a flow through 165 the extraction area 200. An electromagnet filter element 150 is located along the extraction area. The electromagnet element can include an electrostatic charged friction rod. The negative parts of the Dipoles are pulled to the friction rod along with contaminated particles for transferring with water flow to the filters. Tire wear extraction filtration systems can collect debris contaminants, with or without the electric field engaged. Electrostatic rod element 600 can be connected to a timer that is powered through on and or cycles, via a timer. The timer turns on to attract the debris and turns off to wash the debris to the filters. The water / liquid with laden with debris then passes to the filter or through the return hose 145 to the filter.

In an embodiment, the electrostatic rod element 600 can be kept on from the preset timer 125 setting whenever the vehicle is actually moving, and can be turned off while water is allowed to flow for some period of time, e.g. 2 minutes when the vehicle is stopped, to wash the debris to the filter. Alternately, the electrostatic can be turned on for a period of time such as 5 minutes, and then off for a period of time such as 30 seconds to wash the accumulated debris. While some time intervals have been provided the period of time can be between 10 seconds and 10 minutes while the vehicle is not in motion.

An embodiment contemplates using this system in below freezing conditions. In one embodiment, the system can be used with an anti-freeze type substance as the fluid. However, antifreeze itself causes environmental issues even though there are non-toxic vegetable-based antifreeze fluids available, and consequently an embodiment is shown in FIG. 3 uses water which can be the default fluid due to its advantages of adhesion, positive - negative parts of the dipoles in water can aid in moving debris particles towards the collection rod. Fluid, and uses heaters to prevent freezing of all the different locations where the water can be held.

FIG. 3 shows the extraction area 200 that can be manufactured out of a soft rubber so that tire failure or driving over potholes will not damage extraction surface. Lightweight aluminum plates can be inserted as heat sinks with the inlet and outlet hoses. The return hose 145 from the extraction area 200 initially passes through a prefilter 505 which removes the larger particles within the debris. The output of the prefilter passes through the filter element 150, which in this embodiment can be a 0.1 μm filter. In this embodiment, there is a single 0.1 μm particle size capture, however multiple filters and canisters can be in line, and can use additional kinds of filtering including activated carbon, granular charcoal, and catalytic configurations. The cartridges can also include chemicals that remove the that facilitate the collection process such as zeolites or other kinds of absorbing chemicals.

The return hose 145 and supply line hose 112 have heat strips 530, controlled by a temperature control with sensor 531, that senses the temperature of the hoses.

The output of the filter element 150 passes through a heater strip reservoir 510. The heater strip reservoir includes a temperature control 520 and heater strip 575 with sensor 525, where the sensor 525 senses the temperature of the water/liquid in and maintains that temperature at an amount to prevent freezing of the water, for example 40° .

The output of the heater strip reservoir 510 is pumped by a pump 160 through the clean water 114 supply line. The output of the pump may also include a secondary heat strip and sensor again to prevent freezing.

The power connection 550 can either be to the car battery 555 (or vehicle battery), or alternatively can be to an auxiliary battery 560 which can be charged by a separate flywheel magneto generator system 570 that is attached to or otherwise coupled to a standalone motor which is powered by the magneto generating itself to produce 12 V DC current. Power generated to maintain charging together with the voltage regulator and a battery isolator to prevent ground loops. By using a separate battery system, and the self-charging power system, there is no chance of draining the car or vehicle battery using this structure, intended for use but not limited to include internal combustion vehicle configurations, heavy duty, and electric vehicles.

In an embodiment, certain portions of the extraction system can be grounded to reduce static electricity. Tests have shown that the extraction system will collect different kinds of debris including trace amounts of brake dust, rotor shavings from the brakes and tire parts coining off the wheel.

In an embodiment, the pump can be in a soundproofed enclosure with a freeze plug pop out protection and an automatic pressure high shut off for moving debris through the system.

By using the heaters as described above, this forms a management control module protects the system against freezing environments. The management system can trickle power to the heating system while the electric system is turned off. This can also use a secondary battery to avoid overly discharging the main vehicle battery. When a secondary battery is used, it should be used with a battery isolator to avoid problems including ground loops.

In an alternative embodiment, a microcontroller 580 can be used to supply the power to the heat strips, based on the condition for example of the vehicle and the temperatures. In an embodiment, for example, when the microcontroller senses below freezing conditions, it can turn on the power to prevent freezing, and can maintain trickle currents to the heaters when the vehicle is stopped for exceptionally long periods of time.

Thus, specific embodiments of a vehicle tire wear extraction filtration system have been disclosed. It should be apparent, however, to those skilled in the art that many more modifications besides those described are possible without departing from the inventive concepts herein. The inventive subject matter, therefore, is not to be restricted except in the spirit of the appended claims.

1. A tire wear extraction system, comprising;
a tire wear extraction surface comprising a flat or curved extraction surface in proximity to a tire on a vehicle;
a pump assembly, receiving a fluid at an inlet, and pumping the fluid to an outlet;
a fluid source, formed at a top end of said tire wear extraction surface, and providing said fluid over the flat or curved extraction surface;
a fluid sink, formed at a bottom end of the tire wear extraction surface, and receiving the fluid that has passed over the flat or curved extraction surface, and has contaminants therein, and
a filter, which filters the fluid that has passed over the flat or curved extraction surface, and has contaminants therein to remove the contaminants, provides the filtered fluid to the inlet of the pump to be recirculated to the flat or curved extraction surface.

2. The tire wear extraction system according to claim 1, wherein the filter is a sealed filter cartridge.

3. The tire wear extraction system according to claim 2, wherein the sealed filter cartridge is removable and replaceable.

4. The tire wear extraction system according to claim 2, wherein the sealed filter cartridge filters to at least 0.1 micron.

5. The tire wear extraction system according to claim 1, further includes an electrostatic rod element.

6. The tire wear extraction system according to claim 5, wherein said electrostatic rod element is connected to a timer.

7. The tire wear extraction system according to claim 6, wherein said timer powers a charge to said electrostatic rod element to attract debris from said fluid.

8. The tire wear extraction system according to claim 6, wherein said timer powers said electrostatic rod element to attract debris and powers off to wash debris to said filter

9. The tire wear extraction system according to claim 6, wherein said electrostatic rod is powered when said vehicle is moving and powered off while fluid is flowing.

10. The tire wear extraction system according to claim 6, wherein said fluid flows for a period of time of between 10 seconds to 10 minutes while said vehicle is stopped.

11. The tire wear extraction system according to claim 1, wherein said pump is in a soundproof enclosure.

12. The tire wear extraction system according to claim 1, further includes a freeze plug.

13. The tire wear extraction system according to claim 1, further includes a high pressure shut off.

14. The tire wear extraction system according to claim 1, further includes a microcontroller.

15. The tire wear extraction system according to claim 14, wherein said microcontroller controls power to at least one heat strip.

16. The tire wear extraction system according to claim 15, wherein said at least one heat strip operation is based on a condition of the vehicle.

17. The tire wear extraction system according to claim 15, wherein said at least one heat strip operation is based on a temperature.

18. The tire wear extraction system according to claim 15, wherein said at least one heat strip operation is based on a temperature of the fluid.

19. The tire wear extraction system according to claim 1, wherein said flat or curved extraction surface is covered with a screen.

20. The tire wear extraction system according to claim 19, wherein said screen prevents the fluid from splashing or leaking out of said flat or curved extraction surface.
